(19) United States
(12) Patent Application Publication
(10) Pub. No.: US 2006/0134387 A1
(43) Pub. Date: Jun. 22, 2006

(54) Multilayer article formed by adhesive ablation

(76) Inventors: William Gottermeier, Pittsford, NY (US); James Stockschlaeder, Ontario, NY (US); Joseph Wigent, Fairport, NY (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/016,793

(22) Filed: Dec. 20, 2004

(51) Int. Cl. B32B 3/00

(52) U.S. Cl. 428/173

(57) ABSTRACT

A method of manufacturing a multilayer laminated article includes: providing a first layer having a major surface; providing a second layer having a major surface that faces the major surface of the first layer; providing an adhesive layer such that the adhesive extends to at least one sidewall, which is perpendicular to the major surface; removing a length of the adhesive layer from the sidewall back in a direction away from the sidewall, whereby the adhesive is recessed from the at least one sidewall; and laminating the first and second layer with the adhesive disposed there between. In a preferred embodiment, the adhesive is removed by laser ablation. In another preferred embodiment, the article is a potentiometric test element used in a diagnostic analyzer.

### BACKGROUND OF THE INVENTION

1. Field of the Invention

The present invention relates to producing a multilayered laminated article having an adhesive layer selectively removed from the article, particularly a potentiometric test element used in clinical diagnostic analyzer. The present invention also relates to a process for reducing the downtime of an apparatus that manufactures or uses the multilayered laminated article.

2. Description of the Related Art

Multilayer articles are known in the art. For example, U.S. Pat. Nos. 5,540,827 and 4,336,091 disclose multilayer slides (i.e., test elements) that are used as potentiometric assays in diagnostic analyzers, such as the VITROS® 250, 950 and 5,1 FS analyzers manufactured by Ortho-Clinical Diagnostics Corp. U.S. Pat. No. 6,381,169 to Bocian et al. discloses a high density non-volatile memory article, in which laser ablation is used in the manufacture of the memory article. U.S. Pat. No. 6,140,707 also discloses a laminated integrated circuit package where windows are formed by laser ablation. Laser ablation is also known to selectively remove dielectric adhesive layers in the manufacture of flexible printed circuit boards. It is also known to selectively ablate inks on plastic surfaces to create bar codes.

Many multilayer laminated articles often include an adhesive for bonding purposes. For example, the VITROS® potentiometric slides or test elements are made by welding three polystyrene webs together to form a frame, which surrounds the electrodes used in the assays. Slides are cut from the laminate that is produced. The top styrene web used in the slide format is commonly referred to as the cover web having a complex structure. A ribbon of paper, which is imbedded in the cross section of the cover web, serves as an ion bridge for a potentiometic assay. The cover web also has a layer of adhesive that is coated as a stripe beneath the ribbon of paper. The ribbon of paper and adhesive stripe run along the length direction of the cover web. Both are positioned so that they are recessed from the edges of the cover web. The adhesive is used to bond the electrodes (also referred to as “chemistry chips”) to the cover web and also serves as a gasket that prevents assay fluids from flowing along the interface between the chemistry chips and the cover web. When the cover web is welded to the other styrene webs the adhesive stripe is positioned between the webs. Thus adhesive is not exposed on the top or bottom surfaces of the laminate. When slides are cut, the adhesive that is in the cross section of the laminate is exposed at the cut edges of the slide. FIG. 1 shows an isometric schematic view of the cut edge and top of a conventional potentiometric slide. U.S. Pat. No. 4,273,639 discloses potentiometric slides and a preferred method for manufacturing the slides, the disclosure of which is incorporated herein by reference.

The adhesive on the edges of a laminated article, such as the cut edge of potentiometric slides, can transfer to machine components that come in contact with the edge of the article. This can occur with slide assembly machine hardware, resulting in significant downtime because frequent machine cleaning is required. The adhesive also transfers to end user machines where the slides are used such as clinical analyzers. In particular, in some end user machines, for example, clinical analyzers, the slide is transported across multiple stations. The analyzer functions require very accurate positioning of the slides and this is accomplished by using rails that offer only small clearances for slide transport. As the slide rubs against these rails adhesive is transferred and eventually the clearance is reduced to a point where slide jams occur. The result is a significant number of user complaints and significant service call costs.

Potentiometric slides having adhesive recessed from the sidewall of the slides are also known in the art. In these known slides the adhesive is applied selectively to the cover web. That is, adhesive is applied such that it does not contact or abut the sidewall of the finished slide.

### SUMMARY OF THE INVENTION

One object of the invention is to overcome the disadvantages of the known art described above. Another object of the invention is to provide a process for producing a multilayer article that does not transfer, or reduces the transfer, of the adhesive contained therein to the machine that produces the article and to equipment which subsequently uses the article produced by the process. Another object of the invention is to provide a process for producing potentiometric slide or test element where the adhesive used in the manufacture of the slide is recessed from the sides of the slide, in order to reduce or eliminate adhesive transfer from the slide to both the manufacturing equipment used to make the slide and the diagnostic analyzer that the slide will be used on, and a test element produced by the process. Another object of the invention is to provide a process for removing or eliminating adhesive transferred from an article to an apparatus that the article is transported through.

The foregoing and further objects of the invention are accomplished according to one aspect of the invention that provides a method of manufacturing a multilayer laminated article that includes: providing a first layer having a major surface; providing a second layer having a major surface that faces the major surface of the first layer; providing an adhesive layer such that the adhesive extends to at least one sidewall, which is perpendicular to the major surface; removing a length of the adhesive layer from the sidewall back in a direction away from the sidewall, whereby the adhesive is recessed from the at least one sidewall; and laminating the first and second layer with the adhesive disposed there between. In a preferred embodiment, the adhesive is removed by laser ablation. Another aspect of the invention provides a multilayer laminated article that includes: at least two layers each having a major surface that faces the major surface of the other layer; and an adhesive disposed at least partially between the at least two layers, wherein the adhesive extends in a direction to at least one sidewall but the adhesive is recessed from the at least one sidewall. The article is made by a process that includes: providing a first layer having a major surface; providing a second layer having a major surface that faces the major surface of the first layer; providing an adhesive layer such that the adhesive extends to at least one sidewall, which is perpendicular to the major surface; removing a length of the adhesive layer from the sidewall back in a direction away from the sidewall, whereby the adhesive is recessed from the at least one sidewall; and laminating the first and second layer with the adhesive disposed there between. In a preferred embodiment, the adhesive is removed by laser ablation.

Yet another aspect of the invention provides a method of manufacturing a potentiometric test element, which includes the steps of: providing a cover web having a lengthwise ribbon of fibers disposed therein to form an ion junction bridge; applying an adhesive layer to the cover web, wherein the adhesive layer covers at least a part of the width of the cover web that includes the ribbon of fibers; forming one or more apertures in the cover web and adhesive; removing a portion of the adhesive in a region where the sidewalls of the test element will be formed; applying ion-selective electrodes to the cover web; applying one or more further webs over the ion-selective electrodes; laminating the layers form a composite laminate; cutting individual elements in the region of the adhesive removal to form individual test elements having sidewalls formed by the cut. In a preferred embodiment, the adhesive is removed by laser ablation.

Still another aspect of the invention provides a potentiometric test element for use in a diagnostic analyzer. The test element includes: two major surfaces and sidewalls; a cover layer having therein at least two access apertures, the first cover layer forming the first major surface of the element; an ion-junction bridge formed from a sheet of fibers disposed in the first cover layer, wherein the bridge is accessible by the two access apertures; an adhesive layer disposed on the major surface of the cover layer which is opposite the first major surface and beneath the sheet of fibers; two ion-selective electrodes each arranged such that the ion-junction bridge extends between the electrodes; and a first additional layer disposed on the opposite side of the first major surface formed by the cover layer, said electrodes being disposed within said first additional layer; wherein the wherein the adhesive layer extends in a direction to at least one sidewall but is recessed from the at least one sidewall. The test element is formed by a process that includes the steps of: providing a cover web having a lengthwise ribbon of fibers disposed therein to form an ion junction bridge; applying an adhesive layer to the cover web, wherein the adhesive layer covers at least a part of the width of the cover web that includes the ribbon of fibers; forming one or more apertures in the cover web; laser ablating a portion of the adhesive in a region where the sidewalls of the test element will be formed; applying ion-selective electrodes to the cover web; applying one or more further webs over the ion-selective electrodes; laminating the layers form a composite laminate; cutting individual elements in the region of the laser ablation to form individual test elements having sidewalls formed by the cut; whereby the adhesive is recessed from the sidewalls by virtue of the laser ablation.

A further aspect of the invention provides a method of reducing downtime on an apparatus, which includes: inserting the article described above into the apparatus; and transporting the article through the apparatus, whereby the recessed adhesive does not contact the apparatus.

Further objects, features and advantages of the present invention will be apparent to those skilled in the art from detailed consideration of the preferred embodiments that follow.

### BRIEF DESCRIPTION OF THE DRAWINGS

FIG. 1 is an isometric schematic diagram showing the edge of a conventional potentiometric slide.

FIG. 2 is a flow chart of the manufacturing process of the preferred embodiment of manufacturing a potentiometric slide according to the present invention.

FIG. 3 is a schematic top view of a strip to be cut into slides showing various stages of manufacture of the slide including the ablation process of the present invention.

### DETAILED DESCRIPTION OF PREFERRED EMBODIMENTS

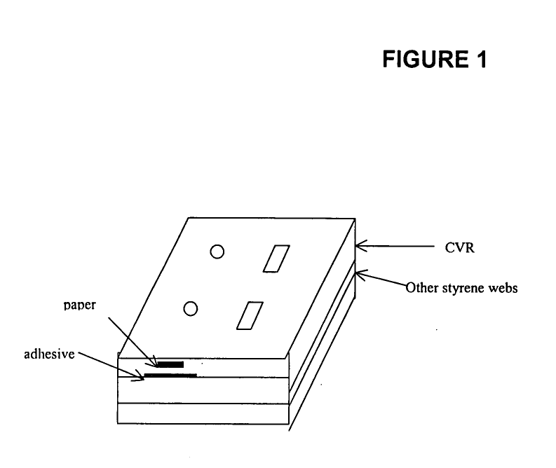

The present invention includes a multilayer laminated article that includes an adhesive and two or more other layers. The adhesive is at least partially disposed between the two layers and is exposed on at least one sidewall of the article which is orthogonal to the major surfaces of the layers as shown in FIG. 1.

In the present invention, the inventors have found an improved process for producing a laminated article that has the adhesive recessed from the sidewall(s) by selectively removing a portion of the adhesive layer initially applied to one of the other layers, such that in the final laminated article the adhesive layer is recessed from the sidewall(s) of the article. As a result, the adhesive will not transfer (or any amount that is transferred will be reduced) from the article to equipment that comes in contact with the edge of the article. That is, the improved format eliminates the propensity for adhesive to be wiped from the side of the article. This adhesive transfer can result in product quality problems and in article assembly machine downtime. While articles, such as potentiometric test elements, have been known that had such a recessed adhesive layer, the present invention provides an improved process for achieving such a recess.

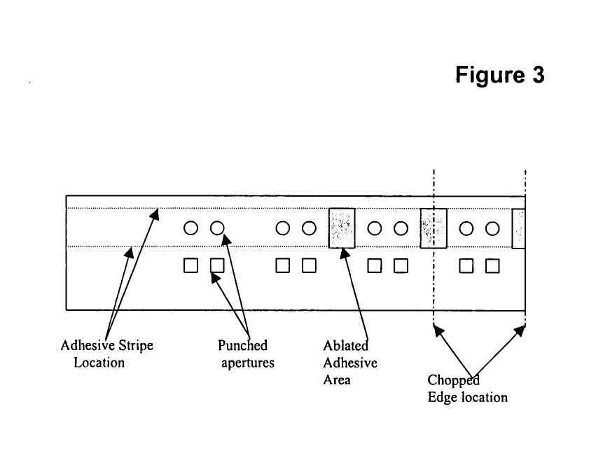

As shown in FIG. 1, the adhesive does not extend the entire width (I) of the article, but does extend the entire length (L). In some embodiments, the adhesive would not have to extend either the entire length or width, the only requirement being that the adhesive be exposed to a side wall of the article, such that the article would benefit from the removal of adhesive at the side by the present invention. In other embodiments, the adhesive may extend both the entire width (I) and length (L). In these embodiments, the adhesive would have to be removed from all the sidewalls where the adhesive was exposed. The distance “x” (FIG. 3) the adhesive is recessed can be adjusted by those skilled in the art to obtain the benefits of the present invention. In a preferred embodiment when the article is a potentiometric slide, the recess obtained by removal of adhesive as measured from the side is preferably in the range of from 0.010 to 0.090 inches, preferably 0.010 to 0.082 inches. The upper end of the range can actually be any dimension that does not extend beyond where the punched edge of the spacer web is located in the slide. Of course, manufacturing tolerances and techniques must be accounted for in determining the length of the recess. For example, FIG. 3 shows that adhesive removal occurs before slides are cut and that adhesive removal is done by a single process step on adjacent slides. Thus, the actual ablation length (y) will be twice the length of the recess. For those embodiments in which the width of the adhesive (z) does not extend along the entire width (z) of the article, the width of the area removed must also be considered in the preferred embodiment. In a preferred embodiment the width (z) of the adhesive stripe is nominally 0.50″. However, the location of the stripe has a large location tolerance. Removing 0.50″ of adhesive will require a larger ablation width to assure that all adhesive is removed at the edge of the slide. As a result, when laser ablation is used, laser energy will strike both the area with the adhesive stripe and a portion of the cover web that has not adhesive. Applicants have found that the laser energy ablates and melts polystyrene at the surface of the cover web. However, the functionality of the cover web is not impacted by this observation.

The adhesive may be removed by any suitable means. In a particularly preferred embodiment, the adhesive is removed by ablation with a laser. It has been found that a CO₂ laser is preferred. Other suitable but less preferable lasers are YAG and Diode Pump lasers. Additives which do not change the functionality of the adhesive but enhance excitation could be utilized. Thus one skilled in the art could accomplish this invention with other types of lasers by the use of additives. Laser ablation is preferred because the adhesive is converted to a vapor which can be easily drawn away from the process. In another embodiment, the adhesive may be removed mechanically, such as using a knife.

The adhesive may be removed before or after all layers of the laminated article are assembled. Specifically, in some embodiments, it may be advantageous to remove the adhesive before a layer is applied covering the adhesive, particularly if mechanical removal of the adhesive is employed. This embodiment is described further in connection with FIG. 3 below.

In other embodiments, it may be advantageous to first assemble the article and then remove the adhesive from the assembled article. For example, a laser could be directed to the sidewall where the adhesive is to be removed. The laser would then ablate the adhesive back to a predetermined distance from the sidewall. If the adhesive is removed mechanically, a knife could be used to scrape or cut the adhesive back to the predetermined distance from the sidewall.

In those embodiments where a laser is employed, as noted above, a CO₂ laser is preferred. The use of lasers, particularly lasers to remove organic solids, such as adhesives are described in U.S. Pat. Nos. 5,523,543 and 4,925,523, both of which are incorporated by reference in their entireties.

Now reference will be made with respect to the detailed description of the preferred embodiments shown in the Figures.

FIG. 1 shows a schematic diagram of a conventional potentiometric slide. The slide includes the polystyrene cover 10 and a ribbon of paper 11 that forms the ion bridge for the slide. In the embodiment shown in FIG. 1, the ribbon is embedded in the cover 10. Through holes 12, 13, 14 and 15 leading to the ion bridge and electrodes (not visible) are also formed in cover 10. A layer of adhesive 16 is provided to bond the rest of the structure, e.g., the additional sheets, electrodes, etc. to the cover 10. As shown in FIG. 1, the adhesive abuts the side of the slide. That is, the adhesive terminates with the other layers such that a continuous sidewall surface is formed that includes the adhesive. As explained above, having the adhesive terminating at the sidewall, can result in the apparatus, (e.g., the diagnostic analyzer), in which the article (e.g., the slide) is used, being gummed up or fouled up due to the adhesive from the article transferring to the analyzer, resulting in downtime to remove adhesive that builds up in the apparatus.

In the present invention the adhesive is recessed from the sidewall of the article by removal of the adhesive, preferably by laser ablation. When the article is a potentiometric slide as depicted in FIG. 1, the adhesive is recessed approximately 0.020″ from the sidewall as shown by dimension “x” in FIG. 3.

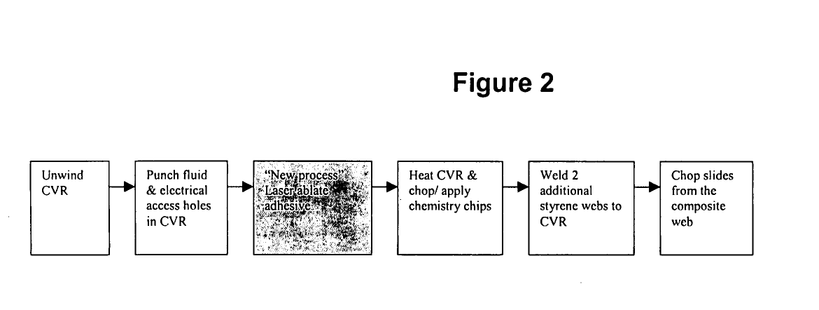

FIG. 2 shows a flow chart of a preferred manufacturing process for a potentiometric slide using laser ablation to remove the adhesive. Complete details of the manufacturing process for potentiometric assay slides, with the exception of the adhesive removal feature of the present invention, is found in U.S. Pat. No. 4,336,091, incorporated herein by reference in its entirety. In FIG. 2, “CVR” stands for cover web or cover sheet. In this embodiment, the cover web is unwound from a roll and the holes 12, 13, 14 and 15 (FIG. 1) are punched in the web. Notably, in the next step, the adhesive is removed by laser ablation before the other layers of the web are applied to the cover layer. This is preferred in that it provides easier access to the adhesive. After ablation of the adhesive, the electrodes (“chemistry chips”) are applied to the heated cover web and adhesive. Additional webs (e.g. 17, FIG. 1) are then provided and the individual slides are then cut or chopped from the web. As shown in FIG. 3, the removal of the adhesive is controlled such that upon the cutting of the web, the adhesive is recessed from the sidewalls of the slide formed by the cutting of the web.

FIG. 3 shows a plan view of a polystyrene cover web at various stages of manufacturing a potentiometric slide using the adhesive removal by laser ablation according to a preferred embodiment of the present invention. As noted above, a cover polystyrene web is provided that already has an adhesive strip applied. The cover web then has apertures 12, 13, 14 and 15 punched in it. In the same manner as shown in the flow chart in FIG. 2, the adhesive layer 16 is selectively ablated with a laser before the electrodes and other webs are applied to form a laminated web. The ablated adhesive is shown in gray with the dimension “y.” In the embodiment shown in FIG. 3, the amount of adhesive removed will be twice the desired recess (“x” as shown in FIG. 3) since upon cutting the dimension will be halved. Of course, the cut or chop does not have to be precisely in the middle of the ablated adhesive area, if different dimensions are desired.

In slides made using the process described above, “edge dams” in the cover web above the area where laser ablation was performed can also be formed. The edge dams are created cutting the paper approximately 1 mm inboard from the edge of the slide so that fluid does not flow to the edge of the slide. The end result is that fluid, which is spotted on a slide and fills the paper bridge, is prevented from flowing to the edge of the slide where it could be transferred to the analyzer. An advantage of the laser ablation process is that it allows the area where the adhesive is removed to also be used for the edge dams. This is significant because in order to minimize the size of slides, there is only 0.10″ at both edges of the slide for both the recess and the edge dam.

As described above, in some embodiments, the adhesive layer (16) could cover the entire width of the web. In those embodiments, the adhesive would be removed from the edges of the web in addition to the adhesive removed as shown by the dimension “y”.

As indicated above, removing the adhesive helps to eliminate or reduce adhesive transfer, not only in the apparatus that is used in the manufacture of the slide as shown in FIG. 3, but also in the diagnostic analyzer that the slide will be ultimately used in. The result of the adhesive being removed from the edges from the slides will reduce downtime and service cost for the diagnostic analyzer.

Thus, another aspect of the invention provides a method of reducing downtime on a machine, such as the test element handler of a diagnostic analyzer, by using the article in the machine. As described above, in using articles that have adhesive exposed to the sidewall, there is a propensity for some of the adhesive to transfer to elements of the apparatus that come into contact with the article. This tendency is enhanced by the specific adhesive required by the potentiometric slide. The softening temperature of this adhesive is well below room temperature so that the gasket properties required of the adhesive are maintained. Thus, the adhesive is soft and can flow when slides are used. The adhesive that is transferred to the apparatus will build up and may cause sticking and jamming of the other elements. As a result, the apparatus may need to be periodically cleaned to removed the built up adhesive. Slide jams can also result in lost patient test results and may render the analyzer unusable for tests that need to be run until a service representative can be brought in to fix the analyzer. By using the article made according to the process of the present invention, the amount of adhesive that transfers from the article to the apparatus will be reduced. The result is no or less buildup of adhesive, resulting in less downtime due to apparatus failure or scheduled maintenance.

It will be apparent to those skilled in the art that various modifications and variations can be made to the compounds, compositions and processes of this invention. Thus, it is intended that the present invention cover such modifications and variations, provided they come within the scope of the appended claims and their equivalents.

The disclosure of all publications cited above are expressly incorporated herein by reference in their entireties to the same extent as if each were incorporated by reference individually.

We claim:

1. A method of manufacturing a multilayer laminated article comprising:
providing a first layer having a major surface;
providing a second layer having a major surface that faces the major surface of the first layer;
providing an adhesive layer such that the adhesive extends to at least one sidewall, which is perpendicular to the major surface;
removing a length of the adhesive layer from the sidewall back in a direction away from the sidewall, whereby the adhesive is recessed from the at least one sidewall; and
laminating the first and second layer with the adhesive disposed there between.

2. A method as claimed in claim 1, wherein the adhesive layer extends to all four sidewalls, and the adhesive is removed from the four sidewalls back in a direction away from the sidewalls, whereby the adhesive is recessed from the four sidewalls.

3. A method as claimed in claim 1, wherein the adhesive is removed in the range of from 0.010 to 0.090 inches as measured from the edge of the sidewall.

4. A method of manufacturing according to claim 1, wherein the adhesive is removed before the laminating.

5. A method of manufacturing according to claim 1, wherein the adhesive is removed after the laminating.

6. A method of manufacturing according to claim 1, wherein the removing the length of adhesive is performed by mechanical cutting or laser ablation.

7. A method of manufacturing according to claim 6, wherein the adhesive is removed by laser ablation.

8. A method according to claim 7, wherein the laser is a CO₂ laser.

9. A method of manufacturing a multilayer laminated article comprising:
providing a first layer having a major surface;
providing a second layer having a major surface that faces the major surface of the first layer;
providing an adhesive layer such that the adhesive extends to at least one sidewall, which is perpendicular to the major surface;
laser ablating a length of the adhesive layer from the sidewall back in a direction away from the sidewall, whereby the adhesive is recessed from the at least one sidewall; and
laminating the first and second layer with the adhesive disposed there between.

10. A method as claimed in claim 9, wherein the adhesive layer extends to all four sidewalls, and the adhesive is laser ablated from the four sidewalls back in a direction away from the sidewalls, whereby the adhesive is recessed from the four sidewalls.

11. A method according to claim 9, wherein the laser is a CO₂ laser.

12. A multilayer laminated article comprising:
at least two layers each having a major surface that faces the major surface of the other layer; and
an adhesive disposed at least partially between the at least two layers, wherein the adhesive extends in a direction to at least one sidewall but the adhesive is recessed from the at least one sidewall, wherein said article is made by a process comprising:
providing a first layer having a major surface;
providing a second layer having a major surface that faces the major surface of the first layer;
providing an adhesive layer such that the adhesive extends to at least one sidewall, which is perpendicular to the major surface;
removing a length of the adhesive layer from the sidewall back in a direction away from the sidewall, whereby the adhesive is recessed from the at least one sidewall; and
laminating the first and second layer with the adhesive disposed there between.

13. A multilayer laminated article as claimed in claim 12, wherein the amount of recess is sufficient to prevent the adhesive from extending or flowing beyond the sidewall when the article is being handled by a machine during manufacturing of the article or while the article is in use.

14. A multilayer article as claimed in claim 12, wherein the recess is in the amount of in the range of from 0.010 to 0.090 inches as measured from the edge of the sidewall.

15. A method of manufacturing a potentiometric test element comprising the steps of:
providing a cover web having a lengthwise ribbon of fibers disposed therein to form an ion junction bridge;
applying an adhesive layer to the cover web, wherein the adhesive layer covers at least a part of the width of the cover web that includes the ribbon of fibers;
forming one or more apertures in the cover web and adhesive;
removing a portion of the adhesive in a region where the sidewalls of the test element will be formed;
applying ion-selective electrodes to the cover web;
applying one or more further webs over the ion-selective electrodes;
laminating the layers form a composite laminate;
cutting individual elements in the region of the adhesive removal to form individual test elements having sidewalls formed by the cut, whereby the adhesive is recessed from the sidewalls by virtue of the adhesive removal.

16. A method as claimed in claim 15, wherein the adhesive layer covers the entire width of the cover web, and the adhesive is removed from the edges of the cover web and in the region where the sidewalls of the test element will be formed, whereby the adhesive is recessed from the sidewalls by virtue of the adhesive removal.

17. A method as claimed in claim 15, wherein the adhesive is removed in the range of from 0.010 to 0.090 inches as measured from the edge of the sidewall.

18. A method of manufacturing according to claim 15, wherein the adhesive is removed before the laminating.

19. A method of manufacturing according to claim 15, wherein the adhesive is removed after the laminating.

20. A method of manufacturing according to claim 15, wherein the removing the length of adhesive is performed by mechanical cutting or laser ablation.

21. A method of manufacturing according to claim 20, wherein the adhesive is removed by laser ablation.

22. A method according to claim 21, wherein the laser is a CO₂ laser.

23. A method of manufacturing a potentiometric test element comprising the steps of:
providing a cover web having a lengthwise ribbon of fibers disposed therein to form an ion junction bridge;
applying an adhesive layer to the cover web, wherein the adhesive layer covers at least a part of the width of the cover web that includes the ribbon of fibers;
forming one or more apertures in the cover web and adhesive;
laser ablating a portion of the adhesive in a region where the sidewalls of the test element will be formed;
applying ion-selective electrodes to the cover web;
applying one or more further webs over the ion-selective electrodes;
laminating the layers form a composite laminate;
cutting individual elements in the region of the laser ablation to form individual test elements having sidewalls formed by the cut, whereby the adhesive is recessed from the sidewalls by virtue of the laser ablation.

24. A method as claimed in claim 23, wherein the adhesive layer covers the entire width of the cover web, and the adhesive is laser ablated from the edges of the cover web and in the region where the sidewalls of the test element will be formed, whereby the adhesive is recessed from the sidewalls by virtue of the adhesive removal.

25. A potentiometric test element for use in a diagnostic analyzer comprising:
two major surfaces and sidewalls;
a cover layer having therein at least two access apertures, the first cover layer forming the first major surface of the element;
an ion-junction bridge formed from a sheet of fibers disposed in the first cover layer, wherein the bridge is accessible by the two access apertures;
an adhesive layer disposed on the major surface of the cover layer which is opposite the first major surface and beneath the sheet of fibers;
two ion-selective electrodes each arranged such that the ion-junction bridge extends between the electrodes; and
a first additional layer disposed on the opposite side of the first major surface formed by the cover layer, said electrodes being disposed within said first additional layer; wherein the adhesive layer extends in a direction to at least one sidewall but is recessed from the at least one sidewall, wherein the test element is formed by a process comprising the steps of:
providing a cover web having a lengthwise ribbon of fibers disposed therein to form an ion junction bridge;
applying an adhesive layer to the plastic strip, wherein the adhesive layer covers at least a part of the width of the cover web that includes the ribbon of fibers;
forming one or more apertures in the cover web;
laser ablating a portion of the adhesive in a region where the sidewall of the test element will be formed;
applying ion-selective electrodes to the cover web;
applying one or more further webs over the ion-selective electrodes;
laminating the layers form a composite laminate;
cutting individual elements in the region of the laser ablation to form individual test elements having sidewalls formed by the cut, whereby the adhesive is recessed from the sidewall by virtue of the laser ablation.

26. A potentiometric test element as claimed in claim 25, further comprising a second additional layer disposed on the first additional layer opposite the cover layer.

27. A method of reducing downtime on an apparatus comprising:
inserting the article according to claim 1 into the apparatus; and
transporting the article through the apparatus, whereby the recessed adhesive does not contact the apparatus.

28. A method according to claim 27, wherein the article is a potentiometric test element used on a diagnostic analyzer and the apparatus is a test element handler of diagnostic analyzer.
